(19) United States
(12) Patent Application Publication
(10) Pub. No.: US 2010/0208906 A1
(43) Pub. Date: Aug. 19, 2010

(54) RESISTANCE IDENTIFICATION OF A PERIPHERAL UNIT ON A HEARING AID

(75) Inventor: Andi Vonlanthen, Remetschwil (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/670,429

(22) PCT Filed: Jul. 26, 2007
(86) PCT No.: PCT/CH07/00368

§ 371 Date: Jan. 25, 2010

(51) Int. Cl. H04R 29/00

(52) U.S. Cl. 381/60

(57) ABSTRACT

In order to identify peripheral units (3A, 3E) on a hearing aid, said units are provided with an identification resistor (R) that is read through the configuration of the hearing aid.

The present invention relates to a hearing aid as specified in the preamble of claim 1, a method as specified in the preamble of claim 9 for producing a hearing aid, as well as a module as specified in the preamble of claim 11 for connecting to the signal-processing unit of a hearing aid.

WO 99/09799, held by the same applicant as for this current patent application, states that hearing aids are extremely complex systems. In order to meet the various user requirements, it is necessary to provide a large number of different hardware configurations, resulting in an extremely cost-intensive, wide variety of models in production, sales and hearing aid fitting, which necessitates the manufacture, labeling and control of a multitude of different device configurations. The distribution network must maintain a corresponding volume of inventory. The fitting of the hearing aids requires a diversity of procedures depending on the device configuration involved.

The mentioned document WO 99/09799 solves these problems by proposing a hearing aid of a design as specified in claim 1 of that document. Accordingly, in the mentioned document a method is proposed for production is proposed as articulated in the preamble of claim 9.

Improving on the aforementioned hearing aid resp. method, it is the objective of this present invention to propose a simple, cost-effective form of execution. This is achieved in that the identification unit is configured as an identification resistor and that, by way of a resistance-measuring unit, said identification unit is functionally connected to the input of the comparator.

This takes into consideration the fact that resistors are available, or can be made, with a wide range of precisely measurable resistance values, for instance as discrete elements or applied by thin-film or thick-film technology, and that the prevailing resistance value can be easily and quickly determined by what is essentially a current/voltage measurement. It follows that a resistor is eminently suitable for use as an identification unit.

Where in this description reference is made to an identification resistor, it is to be understood as an impedance element which, measured at both its connecting points, covers a wide frequency range for instance up to 100 kHz with a substantially predominant real component. An identification resistor of this type may consist of a single resistor or of several resistors connected in series and/or in parallel. As mentioned above, the measured impedance includes a substantially preponderant effective or real component, which does not necessarily rule out an imaginary component due for instance to parasitic capacitances or inductances.

Measuring the resistance on the resistance-measuring unit allows the integrated peripheral device to be recognized by the value of its identifying resistance. By comparing that resistance value with the possible resistance values stored in the memory that contains the available identification variables, in conjunction with the specific characteristics of the peripherals concerned, such as the operating parameters for the signal processing unit, it is possible to use the appropriate parameters according to the particular hardware configuration concerned.

The additional advantages of this concept are as follows:

Once assembled, the hearing aid will identify itself in terms of its hardware configuration.

By virtue of the fact that the comparator output is functionally connected to the input of a configuration memory module and that the hearing aid is provided with a port that connects functionally to the output of said configuration memory module, it becomes possible to read out the hardware constellation of the hearing aid. In many cases that obviates the need for specific labeling, for instance on the packaging, in turn eliminating potential errors in production control, in sales and in the fitting of the hearing aids. It also rules out the possibility of testing, supplying or fitting a given hearing aid on the basis of some erroneously assumed peripheral-hardware configuration. It thus retains the inherent benefits of the general approach according to WO 99/09799 while taking advantage of a supremely simple, fast and precise identification technique according to this present invention, by means of a resistance-based identification.

In one embodiment of the inventive hearing aid, the peripheral device is provided with two ports that are interconnected by way of the identification resistor only. During the identifying resistance measurement of the peripheral device in question, this prevents any intrinsic input impedance from affecting the identification.

In a further embodiment of the inventive hearing aid, the comparator output is functionally connected to an operating control input on the signal-processing unit. This enables the optimal operating parameters assigned to an identified peripheral device to be automatically called upon in the signal-processing unit. If it is detected that an integrated peripheral device is not compatible with the signal processing unit provided, which may be indicated for instance by the absence of the appropriate identification resistance value among the available identification values stored in the identification options memory module, it can block any operation of the peripheral device concerned and/or of the signal processing unit, for instance to prevent potential damage.

The identification options memory module may also contain for instance operating programs for the signal processing unit, designed for driving the corresponding peripheral device, whereby it is possible, e.g. wirelessly via a transceiver or through a hard-wired connection, to block operating routines to be implemented by the signal processing unit if they are incompatible with the identified peripheral device for the respective system configuration.

In another embodiment of the inventive hearing aid, the output of the comparator is functionally connected, as already mentioned above, to the input of a configuration memory module and in a further embodiment, the hearing aid is provided with a port that connects functionally to the output of the configuration memory module. It is thus possible, in any given hearing aid according to the invention, to read out at any time the current system constellation.

In another embodiment of the inventive hearing aid, the peripheral device is a sensor, an actuator, a transceiver, a manual selector switch, a potentiometer, an acoustic/electric input converter or an electric/mechanical output converter.

In a particularly preferred embodiment of the inventive hearing aid, the mentioned peripheral device is a speaker assembly.

According to the inventive production method, the identity of the peripheral device is automatically queried by means of a resistance measurement and then stored.

In one form of execution of said method, the identity of the peripheral device thus ascertained serves to control or select the operation of the signal-processing unit while at the same time preferably locking out any operation extrinsic to that of the selected peripheral device.

In a further form of execution of the inventive method, the identification made by means of the identification resistor causes signals traveling to and/or from the signal-processing unit to be interpreted differently resp. processed differently.

Furthermore, a module is proposed for integration in the signal-processing unit of a hearing aid, featuring two ports that are interconnected exclusively through an identification resistor.

In one embodiment, that module is a speaker assembly for a hearing aid.

With regard to the possibilities generally resulting from the auto-identification of peripheral devices on hearing aids, reference is made to all of the features described in the above-mentioned WO 99/09799 in addition to those described in this present patent application.

Hereinafter, the invention will be explained in more detail with the aid of drawings in which:

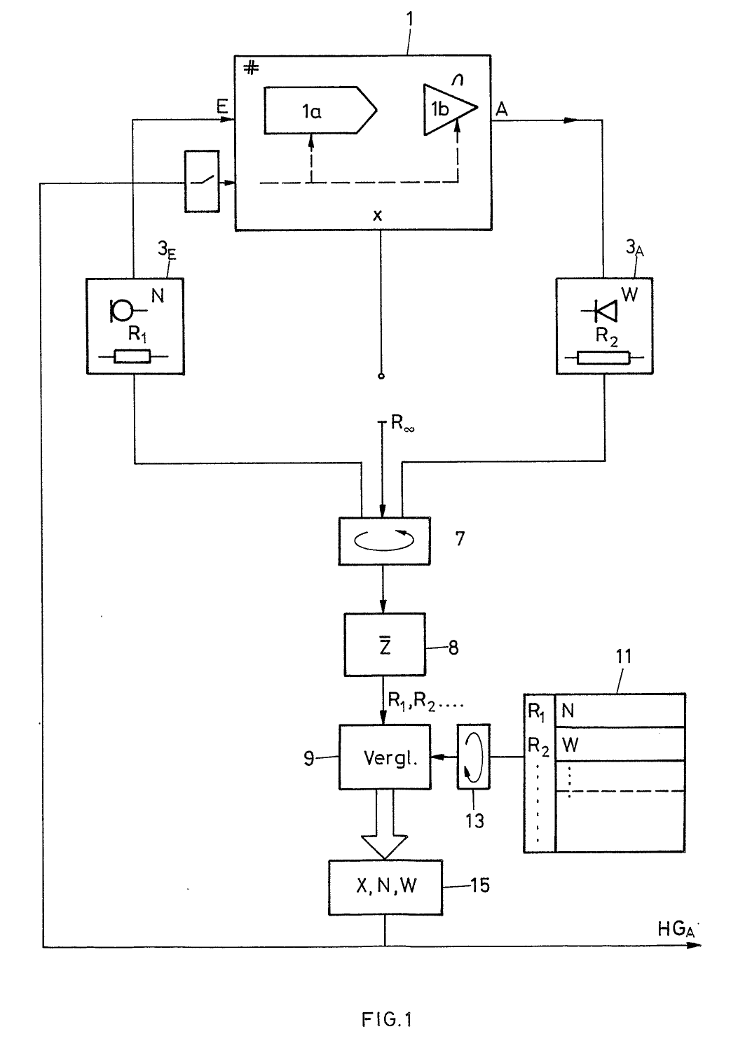

FIG. 1 illustrates the basic operating principle of the inventive hearing aid by means of a signal-flow/functional block diagram;

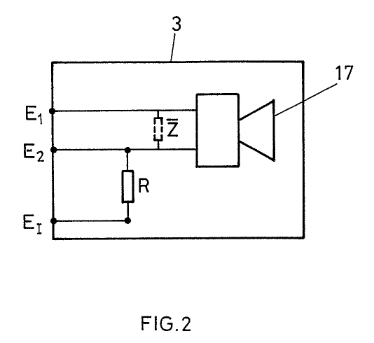

FIG. 2 is a schematic illustration, based on the example of a speaker module, of an inventive peripheral device that can be used according to the present invention.

In the form of a signal-flow/functional block diagram, FIG. 1 illustrates an inventive hearing aid, having, by way of example, two peripheral devices 3_{E} and 3_{A}, configured according to the invention. A signal-processing unit 1, performing digital and/or analog signal processing and represented by the DSP/digital signal processing unit 1a resp. the amplifier 1b, is provided with input and output connections. The output of the peripheral device 3_{E} connects to the input E of the signal-processing unit 1, one output A of the signal-processing unit 1 connects to the input of the peripheral device 3_{A}. The peripheral devices, which connect functionally on their input side and/or on their output side to the outputs and/or inputs of the signal processing unit 1, can be sensors, e.g. microphones, general acoustic/electric converters, communications components such as transceivers, control elements such as program switches or volume controls, actuators, as well as electric/mechanical output converters such as loudspeakers. By way of example only, the peripheral device 3_{E} is illustrated in FIG. 1 as a microphone, the device 3_{A} as a loudspeaker, usually referred to as a “receiver” or “speaker”. In the example shown, each of the two peripheral devices 3 provided is provided with an identification resistor, in the case of the device 3_{E} the identification resistor R1, in the case of the peripheral device 3_{A} the identification resistor R2. The value of either identification resistor R serves as a unique identifier for the associated peripheral device. An identification cycle is triggered according to the hardware configuration of the hearing aid. In that cycle, schematically represented by the cycling unit 7, all identification resistors R are connected, for instance sequentially, to an impedance measuring unit 8, where the identification resistance R of the peripheral device in question is measured. As those skilled in the art are fully aware, the preferred method is a DC resistance measurement by feeding a predefined current to the identification resistors and measuring the resulting voltage on each of the resistors or, conversely, by predefining a particular voltage and measuring the resulting current. An AC-based impedance measurement is equally possible, although, depending on the frequency selected, the influence of parasitic reactances can affect negatively the result of the measurement.

If the measurement shows an infinite resistance value R_{∞}, it indicates that an available port on the signal-processing unit 1 does not have a peripheral device connected to it. The measurement results appearing for instance sequentially on the output side of the impedance measuring unit 8 as a function of the values R₁, R₂, . . . are fed to a comparator 9. The comparator 9 is connected at a second comparator port to an identification options memory module 11. The identification options memory module 11 stores all identification resistance values R₁, R₂, . . . individually mapped to peripheral devices that can be connected to the signal processing unit 1. It is also entirely possible for the signal processing unit 1 to have an identification marker, for instance an identification resistor according to the invention, which (not illustrated) is first measured via the cycling unit 7 and the impedance measuring unit 8 and is then compared with a resistance value (not illustrated) identifying the identification options memory module 11. If these resistance values match, it means that the identification options memory module 11 provided is compatible with the installed signal-processing unit 1, otherwise not: if the identification resistance value on the signal-processing unit 1 does not correspond to the resistance value identifying the identification options memory module 11, all further operations will be aborted and for instance an acoustic or visual alarm will be triggered on the hearing aid or on a port for an external station.

As schematically indicated by the cycling unit 13, this is followed by sequentially determining in the comparator 9, on the basis of the measured resistance values R₁, R₂, . . . , which of the peripheral devices defined in the identification options memory module 11 are present in the system configuration in question. For example, if a type X signal processing unit 1 and type M, N and W peripheral devices are connected, the system configuration XNW will be stored in a hearing aid configuration memory 15 on the output side of the comparator. By comparing the measured resistance values with those saved in the memory module 11 and the resistance-value/peripheral-device correlation assigned therein, the peripheral device concerned will unambiguously be identified.

On its output side, the configuration memory 15 acts on the signal-processing unit. On the basis of the identified hardware configuration at hand, as illustrated with the switching circuit 17, one or several specific processing modes in the signal-processing unit 1 are activated. Depending on the system configuration detected by means of the identification resistors, operating conditions corresponding to that configuration will be selected and activated in the signal processing unit 1, such as for example specific programs in the digital signal processing unit 1a and/or settings such as amplifier adjustments in the analog amplifiers 1b.

In addition, the output of the configuration memory module 15 preferably leads to an output HG_{A} of the hearing aid, whereby the hearing aid in its individualized configuration will be identified for instance on a hearing aid adapter.

FIG. 2 shows in simplified schematic fashion a module resp. a peripheral device according to the present invention, corresponding for instance to the devices 3_{E} and 3_{A} of FIG. 1. Generally, any such preferred peripheral device, individually referred to as a module, will have inputs and outputs corresponding to its particular function, which in the speaker module illustrated by way of example in FIG. 2 would be the inputs E₁ and E₂, to which the electric drive signal for the speaker 17 is applied. An inventive module 3 is provided with an identification resistor R which can preferably be measured via connections in a manner whereby any self-impedances of the module, indicated by dashed lines Z, will have either no or only a negligible influence on the determination of the value of R. As shown in FIG. 2, the identification resistor R is preferably connected with one of its contacts to one of the module ports, E₂, and lead to a third port, E₁ in FIG. 2. Consequently, a module according to the invention is provided with the ports corresponding to its function for the signal inputs and/or outputs as well as a further additional port, and the identification resistor R is switched between that additional port and one of the contacts on the module.

The hearing aid and the method according to the present invention provide in an exceedingly simple manner a true, modular plug-and-play hearing aid system, permitting a dramatic reduction of the cost of manufacture, a minimized circuitry configuration in a signal processing unit of the hearing aid and maximal elimination of incorrect packaging, incorrect configurations, incorrect fitting etc. due to human inattention, the identification technique being extremely simple, reliable and easy to manipulate in terms of a quick detection of its identification. For the identification of units equipped with the identification resistor and for measuring the corresponding resistance value, only few additional provisions are needed on already existing units, which in the case of peripheral module devices include the supplying of an additional resistor and, on the receiver side, the supplying of a brief voltage or current injection on one of the connectors with a correspondingly brief current or voltage measurement.

What is claimed is:

1. A hearing aid with a signal-processing unit, which is functionally connected on its input side and/or on its output side to a digital, hybrid or analog peripheral device, said peripheral device comprising an identification unit whose output effectively connects to a comparator, with the input side of the comparator being functionally connected to an identification options memory module, wherein the identification unit is in the form of an identification resistor whose contacts functionally connect to the comparator via a resistance-measuring unit.

2. The hearing aid according to claim 1, wherein at said contacts, only the identification resistance can be measured.

3. The hearing aid according to claim 1, wherein the output of the comparator is functionally connected to an operating control input on the signal-processing unit.

4. The hearing aid according to claim 1, wherein the output of the comparator is functionally connected to the input of a configuration memory module.

5. The hearing aid according to claim 4, wherein the hearing aid is provided with an output that connects functionally to the output of the configuration memory module.

6. The hearing aid according to claim 1, wherein the peripheral device is: a sensor, an actuator, a transceiver, a manual selector switch, a potentiometer, an electric/acoustic output converter, or an acoustic/electric input converter.

7. The hearing aid according to claim 1, wherein the peripheral device is an electric/mechanical output converter in the form of a speaker.

8. The hearing aid according to claim 7, wherein the speaker is provided with at least three output ports, namely two speaker outputs and one additional output port, with the identification resistor being connected to one of the speaker ports and to the said additional port.

9. A method for producing a hearing aid with a signal processing unit and, connected to the latter, at least one peripheral device, wherein the peripheral device is installed with the signal processing unit, then the identity of the peripheral device is automatically queried and stored in memory, wherein the identity of the peripheral device is determined by means of a resistance measurement.

10. The method according to claim 9, wherein the identity of the peripheral device so determined selects the operating mode of the signal-processing unit and preferably blocks any operation extrinsic to the peripheral device and/or to the signal-processing unit in question.

11. The method according to claim 9, wherein as a function of the identification, signals traveling to and/or from the connections of the signal-processing unit are interpreted differently and/or processed differently.

12. A module for connection to the signal-processing unit of a hearing aid, equipped with inputs and/or outputs corresponding to the function of the module, wherein two of its output ports are connected by an identification resistor.

13. The module according to claim 12, wherein it is a speaker module.
